(19) United States
(12) Patent Application Publication
(10) Pub. No.: US 2024/0009720 A1
(43) Pub. Date: Jan. 11, 2024

(54) METHOD TO ENABLE RECYCLING OF A PANEL

(71) Applicant: COVESTRO (NETHERLANDS) B.V., Geleen (NL)

(72) Inventors: Alwin PAPEGAAIJ, Geleen (NL); Henrica Gertruda Maria VAN DER STEEG, Geleen (NL); Jan Henderikus UDDING, Geleen (NL)

(21) Appl. No.: 17/769,036

(22) PCT Filed: Oct. 19, 2020
(86) PCT No.: PCT/EP2020/079351

§ 371 Date: Apr. 14, 2022

(30) Foreign Application Priority Data
Oct. 17, 2019 (EP) 19203956.8

(51) Int. Cl. B09B 3/80

(52) U.S. Cl. CPC B09B 3/80; B27N 3/007

(57) ABSTRACT

The present invention pertains to a method to enable recycling of a panel comprising as a core structural component a polysaccharide fibre based plate at least one side of which is covered with a layer of a non water soluble adhesive, the method comprising immersing the panel in an aqueous liquid at least until the polysaccharide fibre based plate has absorbed an amount of liquid that leads to detachment of the adhesive from the polysaccharide fibres and at least partial detachment of neighbouring polysaccharide fibres from each other, resulting in a mixture of at least partially individualised polysaccharide fibres and separate adhesive, and thereafter removing the adhesive from the mixture.

### GENERAL FIELD OF THE INVENTION

The invention is directed to the design of a panel, while at the same time enabling a re-use of the constituting components of the panel after its end-of-life. In other words, the invention pertains to a so-called design for re-use in the area of decorative and structural panels.

### BACKGROUND

In the manufacture of furniture, cabinets, household articles, counter tops, floor and wall decorations and the like, it is known to use panels. In general, a panel is comprised of a core structural component in the form of a plate to which a surface covering such as a laminate is provided in order to provide for a functional and decorative surface. The surface covering typically consists of a sheet material that is adhered to one or more of the planar portions of the panel. The surface covering provides for an aesthetic and durable use of the panel. In recent years, a lot of attention has gone to developing sustainable laminates for covering panels which led i.a. to the development of new types of high pressure laminates (HPL, produced by saturating multiple layers of kraft paper with phenolic resin), thermally fused laminates (TFL, wherein a resin-impregnated sheet of décor paper is fused directly to a panel), new types of decorative papers and foils (mostly pre-impregnated with a blend of melamine, acrylic and urea resins) and new types of rigid thermoformable foils (RTF, thermoplastic 2D and 3D coverings). Also, a lot of development has gone into finding alternatives for wood as a resource for making panels. Panels made of the fibrous residue of sugarcane, beets, grain, or panels made of paper waste, stone, recycled and recovered wood materials etc. have been described in the art, aiming at a design that has a lower impact on the availability of natural resources.

Little attention has been given to the recycling of the panel after its end of life by separating the various constituting materials. Although there is an apparent need for such separation, the attention has been directed to obtaining a functional, durable and strong bond between the panel and its surface covering, instead of to the possibility of separating the panel from its surface covering. This has increased the problem of recycling: the purpose of the adhesive is to keep the various layers, such as the plate and the surface covering, durably together, whereas true recycling demands that the materials can be easily separated. Another inherent problem is that the materials from which a plate for use as a core in a structural panel is made differ completely, both physically and chemically, from adhesives. The latter are typically polymer based, while the plate materials are typically natural fibre based.

Recycling of panels durably provided with a surface covering typically takes place by shredding the panels, form a (mixed) particulate material and use this material to form new sheet shaped material (see e.g. US 20140075874). However, the new material, due to the mixed content of panel material and surface covering material, is typically of a lower quality than any of the starting materials as such. Although small amounts of adhesive mixed into a recycled plate material may not be a principle problem, the number of times a panel can be recycled this way is not endless. Another technique used is to simply mill the surface covering of the panel, enabling up to about 85% of the panel material to be reused again.

As a consequence little improvement has been made in the field of panels actually designed to enable complete re-use of the materials, in particular a re-use of the plate material without inherently including substantial amounts of adhesive into the recycled material. Indeed, in practice the design has led to improvement of the adhering properties of the adhesive that have led to panels with a strong permanent connection between the panel and its covering.

### OBJECT OF THE INVENTION

It is an object of the invention to provide a new method that enables recycling of a panel, in particular enabling reuse of up to 100% of the core plate material while diminishing or preventing the inclusion of adhesive into the recycled materials.

### SUMMARY OF THE INVENTION

In order to meet the object of the invention a method to enable recycling of a panel covered with adhesive has been devised, wherein the panel must comprise as a core structural component a polysaccharide fibre based plate, and the adhesive must be a non water soluble adhesive, and wherein the method comprises immersing the panel in an aqueous liquid at least until the polysaccharide fibre based plate has absorbed an amount of liquid that leads to detachment of the adhesive from the polysaccharide fibres and at least partial detachment of neighbouring polysaccharide fibres from each other, resulting in a mixture of at least partially individualised polysaccharide fibres and separate adhesive, and thereafter removing the adhesive from the mixture.

Surprisingly it was found that when the design of a panel incorporates the above described limitations, the separation of the plate material and adhesive can quite easily be obtained by simply immersing the panel in water (or an aqueous liquid). Although the plate materials made from polysaccharide fibre for use in structural panels must be quite dense, typically they have a density around 1000 kg/m3, and thus, the plate materials are non-porous, it appeared that due to the highly hydrophilic nature of the polysaccharide fibres, water can easily be absorbed. When allowing sufficient time to pass (depending i.a. on the geometry of the panels, the presence of coatings on one or more sides thereof etc.) it appeared that the adhesive automatically detaches from the fibres (i.e. from the bulk of the fibres, leading to adhesive flakes or other forms of adhesive to be separated from the plate, but not excluding that some individual fibres remain bonded to the adhesive), independent of the type of adhesive. In the most advantageous situation, the adhesive will even come loose from the panel as a complete film, with little or no fibres attached to it. It seems that the inherent affinity between water molecules (or molecules comprised in the liquid having comparable hydrogen bonding capabilities) and the polysaccharide fibres is stronger than the affinity between polymer molecules (part of any adhesive) and the polysaccharide fibres. When allowing sufficient time for the water molecules to break the bonding between the polysaccharide fibres and the polymer molecules in the adhesive, ultimately the adhesive will (completely) detach from the fibres, notwithstanding that some fibres may stick to the adhesive. Typically the mass of fibres contaminating the separated adhesive will be less than the mass of the separated adhesive itself. However, even in case the mass of such fibres is about ten times as high as the mass of the separated adhesive, this still means that 99% or more of the total amount of fibres in the panel are separated from the adhesive. Preferably, the mass of the fibres contaminating the adhesive is less than 10 times the mass of the adhesive, such as for example 9 times, 8, 7, 6, 5, 4, 3, 2, 1, 0.5 or even less. A concomitant advantage of the novel method is that the fibres in the plate itself also (at least partly) detach from each other, such that ultimately a mixture is formed in the aqueous liquid having relatively large (at least macroscopic) portions of the adhesive, and small parts of the plate material (up to even individual fibres). From such a mixture, it is very easy to remove the adhesive, for example by picking out the adhesive parts by hand using a coarse screen.

The inventive method, as long as the above design limitations are adhered to appears to be effective for adhesives from the various types that are used for producing structural panels. Typical types of adhesives use for making panels are thermosetting, thermoplastic and contact adhesives. Thermosetting adhesives cure at room temperature or in a hot press by chemical reaction, to form a network of rigid bonds (crosslinks) that are not re-softened by subsequent exposure to heat. The most commonly used are urea-formaldehyde adhesives, resorcinol and phenol-resorcinol adhesives. Thermoplastic adhesives harden at room temperature through loss of water or solvent and re-soften upon subsequent exposure to heat. The most commonly used are polyvinyl acetate adhesives (white glue) and catalyzed polyvinyl acetate adhesives. Contact adhesives can be water- or solvent-based and are suitable for bonding laminates to most substrates. They must be applied to both mating surfaces and dried before bonding. Laminating can be accomplished at room temperature. High strength, water-resistant bonds are developed almost immediately upon contact between both coated surfaces. The glue line remains flexible, allowing the surface covering to expand and contract independently of the substrate, which minimizes the tendency of the finished panel to warp. The common part in all of these adhesives is the presence of polymer molecules. Apparently, the types of molecules used all have less affinity with polysaccharide fibres than water molecules have.

### Definitions

A panel is a solid, self-supporting (dimensionally stable) substantially two dimensional object, i.e. a broad and thin, having length and width dimensions that are at least 10 times larger than its height dimension, preferably at least 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 200, 300, 400, 500 up to 1000 times or more longer or wider than its height (i.e. it's thickness in the direction of its smallest dimension), which object is typically but not necessarily rectangular, typically but not necessarily flat (the panel may be curved, corrugated, etc.), and usually forms or is set into the surface of a larger substrate such as a door, a wall, a ceiling, a piece of furniture, a tray etc. A panel intrinsically has stable dimensions, but depending on its thickness a panel may be marginally flexed under stress. Typical examples of types of materials out of which panels are made for use in the construction of buildings, furniture and other household articles are OSB (oriented strand board), MDF (medium density fibreboard), PUR (polyurethane, mainly for insulation panels), PE (polyethylene, mainly for sandwich panels, or HDPE or any other type of high end PE), cellulosic fibre, wood, but may also be rubber, metal paper etc. A panel by itself may have a multilayer structure such as for example known from honeycomb panels. Typical weights for panels used in buildings, furniture and household items are between 2 and 50 kg/m², in particular between 3 and 30 kg/m² (as opposed to for example veneer or other surface laminates which have weights in the order of 0.4 to 0.8 kg/m²), or cardboard and paper coating materials which have weights below 0.6 (for cardboard) and 0.18 kg/m² (for paper) respectively.

A polysaccharide fibre based object is an object that consists at least for 50% (w/w) of polysaccharide fibres, for example for 51, 55, 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 up to 100% w/w of these fibres, i.e. macromolecules composed of long chains of at least 10 monosaccharide units bound together by glycosidic linkages. Polysaccharides fibres belong to the class of so called structural polysaccharides (as opposed to storage polysaccharides such as starch and glycogen) and range in structure from linear to highly branched. Examples include cellulose, chitin, arabinoxylan and pectin. Typical polysaccharide fibre based panels are panels such as plywood, oriented strandboard, particleboard, and fibreboard.

A plate is a flat thin piece of rigid material, i.e. a material not able to be forced out of shape under circumstances that are representative for its intended use.

A non water soluble material is a material which cannot be solved for more than 5% in water at room temperature, preferably not more than 4, 3, 2, 1 or even 0%.

An aqueous liquid is a liquid that consists at least for 50% (v/v) of water. It may consist for more than 55, 60, 65, 70, 75, 80, 85, 90, 91, 92, 93, 94, 95, 96, 97, 98, 99 up to 100% out of water. The liquid may be used as a solvent or dispersing medium for other materials.

An adhesive is any non metallic substance than can be applied to one surface, or two surfaces of two separate items that is able to bind these surfaces together and can resist their separation after a normal drying/curing time. Typical classes of adhesives are contact adhesives such as pressure sensitive adhesives, reactive (curable) adhesives, elastomer adhesives, waxes and hot melt adhesives.

A hot melt adhesive is a thermoplastic adhesive that is designed to be melted, i.e. heated to above a melting temperature to transform from a solid state into a liquid state, (the melting temperature may be a melting range of a few degrees or more) and to adhere materials after solidification. Hot melt adhesives are typically non-reactive, (partly) crystalline and comprise low (less than 5, 4, 3, 2, preferably even less than 1 mass %) or no amount of solvents so curing and drying are typically not necessary in order to provide adequate adhesion. In the liquid state the adhesive has a suitably low viscosity, is tacky and solidifies rapidly after cooling down to below its melting temperature (typically in a few seconds to one minute), with little or no drying needed. Unlike a pressure sensitive adhesive, a hot melt adhesive is not permanently tacky. Unlike solvent based adhesives, a hot melt adhesive does not shrink substantially or lose thickness as it solidifies.

A binder is a substance used to make other substances or materials stick or mix together. Often a binder is a synthetic resin.

To cover means to appear on the surface of something.

Cellulosic means made from cellulose or a derivative of cellulose (such as for example viscose or rayon).

A fibrous material is a material comprising fibres as (one of) its basic constituent(s). Examples of fibrous panels are boards pressed of wood fibres, wood particles, wood chips or of other plant materials.

An individualised fibre is a fibre which is not bonded with any neighbouring fibres via chemical or hydrogen bonds, not excluding physical entanglements.

A layer is a thickness of some material laid on or spread over a surface in a continuous manner, although a layer may have occasional spots or interruptions or may have a regular pattern of spots or interruptions (for example a reticulated layer).

### EMBODIMENTS

In a first embodiment of the method of the invention, in which method the adhesive is a solid while the panel is immersed, the adhesive is removed using a mechanical method such as sieving, sedimentation or centrifugation.

In another embodiment the at least one side of the panel is substantially completely covered with the layer of adhesive. It was surprisingly found that even when a complete side of the plate is covered with a non water soluble adhesive, the present method can still be successfully performed. It may be that the time needed for a sufficient absorption of the liquid is long, but ultimately, detachment of the adhesive will occur.

In yet another embodiment the panel is mechanically broken up into pieces having a volume of at most 100 cm³ before it is immersed in the aqueous liquid. This embodiment was found to be particularly useful when all surfaces of the plate are covered with adhesive. In all other cases, this embodiment simply allows shorter process times. Preferably the panel is mechanically broken up into pieces having a volume of at most 50 cm³, for example at most 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2 or even less than 1 cm³ before it is immersed in the aqueous liquid. Smaller volumes lead to a shorter time for the immersion process to complete sufficient separation of the adhesive from the fibres.

In again another embodiment the adhesive is a hot melt adhesive. Although the use of hot melt adhesives to produce panels is described in the art, it is not known to use in particular this type of adhesive in the design of a recyclable panel. For example, U.S. Pat. No. 4,089,721 shows the use of a hot melt adhesive for covering a core structural plate with a decorative surface laminate for making furniture. Indeed, the method is not recognized as providing a product that can be re-used by separating the surface laminate from the in any way. At first glance, the most obvious way for separating the surface laminate from the plate would seem to be to heat the adhesive to a temperature above its melting temperature, upon which the adhesive becomes a liquid no longer having bonding properties, and then simply separating the plate from the laminate. However, a skilled person would understand that this is not practically doable. The most apparent reason for that is that the hot melt adhesive chosen has a very high melting temperature. Apparently, in order to safeguard that the bonding between the surface laminate and panel is stable even at elevated temperatures, the hot melt adhesive chosen melts only above 175° C.-230° C. (350°-450° F.). This means that for re-melting the hot melt adhesive, the object as a whole needs to be heated to a temperature above at least 175° C.-230° C. This is not only very uneconomical, but also generates the risk of overheating the object, often mainly of wood and plastic, possibly setting it on fire (dry wood can self-inflame starting at about 200° C., processed wood such as structural board and some plastics even at temperatures as low as 175° C.). Also, the high temperature needed for separation makes it very difficult to remove the thin surface laminate (typically below 1 mm in thickness) from the panels, since the laminate, comprising a polymer layer, becomes less stable at these high temperatures.

It was applicant's recognition however that with the current process, heating the adhesive can be completely dispensed with so that none of the obvious problems that go along with heating need to occur, even if the hot melt adhesive has a melting temperature between 80° C. and 250° C., for example around 85, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 155, 160, 165, 170, 175, 180, 185, 190, 195, 200, 205, 210, 215, 220, 225, 230, 235, 240, 245 up to 250° C. or any temperature in between two consecutive temperatures as explicitly mentioned. A type of hot melt adhesives known from a remote field of technology, i.e. the manufacturing of textile products, is very suitable for use in the present invention. This type of adhesive is described in WO 2014/198731, starting at page 27, line 8 (“useful hot melt adhesives . . . ”) and ending on page 38, line 18 (“ . . . observed in this range”).

Still, in another embodiment the hot melt adhesive comprises a polyester polymer. A polyester polymer has found to be useful for application in the present invention. In particular useful is a condensation polymer. The polymer may have a weight averaged molecular weight (Mw) between 15,000 and 30,000 g/mol. In particular, the weight averaged molecular weight advantageously has a value of 15001, 15500, 16000, 16500, 17000, 17500, 18000, 18500, 19000, 19500, 20000, 20500, 21000, 21500, 22000, 22500, 23000, 23500, 24000, 24500, 25000, 25500, 26000, 26500, 27000, 27500, 28000, 28500, 29000, 29500 up to 29999 g/mol or any other value in between two consecutive values of these. In particular, the polymer may have a crystallinity of between 5 and 40%. Regarding the crystallinity, this can have any value between 5 and 40% such as 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38 and 39%. Typical ranges are 5-30 and 10-30%.

In yet another embodiment wherein the panel is a multilayer panel comprising multiple stacked sub-panels, each sub-panel comprises as a core structural component a polysaccharide fibre based plate and in that the sub-panels are interconnected using the said non water soluble adhesive. The present invention was found to be useful also for recycling so called multi-layer panels, which are widely used in the industry but for which no other means than shredding (incorporating the adhesive into the shredded plate material) and burning it as a fuel are commonly used for recycling.

Depending on the adhesive applied, the fibres remaining on the separated adhesive can be removed by yet another separation step, e.g. through heating and/or melting of the adhesive by which the fibres will separate from the liquified adhesive and thus can easily be removed by sedimentation, sieving, centrifugation or any other suitable method. In the most advantageous case, the purified adhesive can be reused as adhesive again. Especially hot melt adhesives appear to be suitable for re-use when applying this method. More beneficially, polyester based hot melt adhesives are found to be particularly suitable.

In a further embodiment the multilayer panel is provided with a surface coating that is impervious to water. In principle any coating material for the multi-layer panel can be applied in the present invention, such as for example wood based veneers, metal veneers, ceramics, fibreglass reinforced plastics, high pressure laminates, glass finishes, paper based phenolics such as Formica, fabrics etc. However, it was found that heat curable one component powders as known from WO 2010/136315 are particularly useful for providing a water impervious coating on panels according to the present invention (the one component powders after curing can be considered an adhesive in the sense of the present invention). To applicant's surprise, against prior art teachings, a multilayer panel can be manufactured in one process step, in which step also the water impervious coating is applied. It was even more surprising that this can be achieved using polysaccharide fibre based sub-panels, since these panels are inherently hydrophilic and thus inherently contain water which was always believed to be detrimental for applying a water impervious surface coating without sufficient drying of the multi-layer panel after its assembly out of multiple sub-panels. Another surprise was that this can be achieved using a hot melt adhesive instead of the usual (hydrophilic) thermoset resins or water based glues. A hot melt adhesive is highly viscous upon cooling and does not penetrate into the panels along the polysaccharide fibres, at least not to the extent for example a water based adhesive does. A good penetration is believed to be a requisite for manufacturing a durable multilayer panel. Another important reason why hot melt adhesives are typically not used for making polysaccharide based panels, is that the polysaccharide used most widely, i.e. cellulose of natural origin (e.g. from wood, plant fibres etc.), cannot be heated above 100-105° C. without some level of deterioration such as for example caramelization of residual sugars. Typically, hot melts for use in constructions have a melting point well above 105° C. to avoid delamination.

In yet a further embodiment the surface coating is a coating that is formed in situ on the panel using a heat curable one component powder. Preferably, the powder comprises a thermal initiation system comprising a peroxide, preferably an organic peroxide. The powder may comprise a polyester resin and a co-crosslinker chosen from the group of vinylethers, vinylesters, methacrylates, acrylates, itaconates and mixtures thereof.

In again another embodiment the polysaccharide fibres are cellulosic fibres. Cellulosic fibres are typically derived from fibrous pulp of plant material such as wood, or any material from plants of the family of poaceae or gramineae, a large and nearly ubiquitous family of monocotyledonous flowering plants known as grasses. Poaceae includes the cereal grasses, bamboos, cane, reeds and the grasses of natural grassland. Typical examples of materials used are wood chips and particles, fibres of cane, reed, flex and hemp, and fibres of grains such as brewers grains. In yet a further embodiment the fibrous material comprises artificial polymer (i.e. a man-made polymer) in addition to the cellulosic fibres. Panels made of a combination of cellulosic fibres and artificial polymer material have recently been introduced to the market by ECOR (San Diego, USA) as an alternative to particle board, and can be made for example from recycled coffee cups or recycled milk cartons. These panels are ideally suitable to be used in the present invention. Also, the panels can be made of a combination of cellulosic fibres and non-cellulosic material, the latter in amounts of up to 50% w/w. Such non-cellulosic material may vary from protein-based fibres of natural origin (such as for example from feathers) to various textile fibres, whether of natural origin or not (from example from recycled clothes or household textiles). Preferably, the polysaccharide fibres are of plant origin such as hemp, ramie, cotton, flax, linen, wood.

In yet another embodiment the polysaccharide fibre based plate contains less than 5% binder, preferably less than 4, 3, 2 or 1% binder up to even no binder. It is believed that a binder may interfere with the water molecules detaching the adhesive and individualising the polysaccharide fibres. Less binder may result in a faster process. An example of a sub-panel with no binder that can be used in the present invention is the ECOR panel available from ECOR, San Diego, USA.

The invention will now be explained on the basis of the following particular but non-limiting examples.

### EXAMPLES

### Example 1

A first experiment was carried out on lab scale wherein small structural plates for use in manufacturing structural panels were coated with an adhesive, in order to test separation of the plate and adhesive using the method of the invention. Three small plates (approximately 10×6 cm) cut out of so-called “ECOR panels” (ECOR FlatCOR

UA Brown, manufactured in Serbia, available via ECOR R&D Center BV, Venlo, Netherlands; polysaccharide fibre based plates from 50% old corrugated containers and 50% virgin papermaking fibre) were coated with a polyester hot melt adhesive. The first two plates were coated on one side with 150 and 170 g/m² respectively. The third plate was coated on both sides with about 150 g/m². All of the plates were broken up in small pieces by a household blender of 1400 Watt (Bagimex: BL10-powerblender). Of each sample, 150-200 grams of the broken material was immersed in water for 4 consecutive days. During these 4 days the water uptake was about 100% (each gram of panel absorbed about one gram of water). After this, a mixture was obtained resembling pulped paper, clearly indicative of the polysaccharide fibres being at least partially individualised. More importantly, flakes of adhesive separated from the plate material were visible in the resulting mixture. These flakes could be easily removed using a coarse screen. After removal of the adhesive, the remaining mixture was tested for the presence of adhesive by assessing potential phase separation. No such separation could be seen and a homogenous polysaccharide fibre layer was formed through sedimentation. The mixture apparently consisted (mainly) of water and polysaccharide fibres. The mixture was blended and a new plate could be formed using a Büchner funnel and subsequent pressing of the cake in a hot press at 177° C., 209 psi for 5 minutes.

### Example 2

A second experiment was carried out on a larger scale. An ECOR panel of the same type as used in example 1, weighing approximately 4 kg, was coated one sided with a polyester hot melt adhesive (about 100 g/m²). The panel was sawn into strips having dimensions of about 10 cm×120 cm. The strips were immersed in water overnight. After one night of immersion into water, the adhesive could be very easily separated from one of the strips. Thus, it looked like the fibres were detached form the adhesive after this one night of immersion only. To be sure of this, the remaining strips were broken up into smaller pieces (as described under example 1) and immersed again for 10, 20 or 30 minutes respectively. With increasing amount of time, more and more flakes of adhesive (having an approximate size of 1 cm²) became visible. Actually, the adhesive could almost completely be removed as a film with the same size as the panel pieces. The difference between 20 and 30 minutes was small, thus assuming that after 30 minutes almost all adhesive was separated from the panel pieces. The soaked panels were pulped during 30 minutes in an 80 litre pulper (BI-pulper) as is used for paper at 10% dry solids content. The adhesive flakes could be easily removed from the fibres using a 3 mm screen.

Microscopic analysis of the remaining mixture revealed that a small amount of tiny pieces of adhesive, having an approximate diameter of 0.3 mm were still present in the aqueous mixture. These pieces could be removed using a screen with 0.2 mm slits. About 8 kg of mixture remained (water plus about 1.6 kg of polysaccharide fibres) which was used to produce a new panel in a hot press. This panel was of a good quality, no traces of the adhesive were visible. Also, the panel did not stick to the metal screens in the press, which confirms that hardly any to no adhesive was present on the surface.

### Example 3

15 grams of Pattex D2 wood glue was applied onto an ECOR 100% deinked pulp (DIP) FlatCOR platelet (Ø˜12 cm; 18 g) in stripes and distributed into one layer with a spatula. Another ECOR 100% deinked pulp (DIP) FlatCOR platelet (Ø˜12 cm; 29 g) was put onto it. This sandwich was left to dry for 12 days at room temperature with a weight of 1600 grams on top of the sandwich. After that the sandwich was cut axially in two identical circle segments.

One half of the dry sandwich (24 g) was left in 1 l water for 10 minutes to soak completely. The ECOR platelets could be taken apart at the side and it was clear that the glue could be removed as one continuous film.

The other half was torn apart by hand. All wet material was repulped with a household blender (Bagimex: BL10-powerblender, 1400 Watt) during 20 s at intensity 4. A thick pulp of about 2.5% dry solids was obtained. White pieces of the glue film were clearly visible. These pieces could be rubbed apart between the fingers. This indicates that the remaining DIP fibers can be separated from the adhesive film particles by gentle screening.

### Example 4

9.3 grams of Bison D2 wood glue was applied onto an ECOR 100% deinked pulp (DIP) FlatCOR platelet (Ø˜12 cm; 35 g) in stripes and distributed into one layer with a spatula. Another ECOR 100% deinked pulp (DIP) FlatCOR platelet (Ø˜12 cm; 12 g) was put onto it. This sandwich was left to dry for 12 days at room temperature with a weight of 1600 grams on top of the sandwich. After that the sandwich was cut axially in two identical circle segments.

One half of the dry sandwich (28 g) was left in 1 l water for 10 minutes to soak completely. The ECOR platelets could be taken apart at the side and it was clear that the glue could be removed as one continuous film.

The other half of the sandwich was subsequently torn apart by hand. All wet material was repulped with a household blender (Bagimex: BL10-powerblender, 1400 Watt) during 20 s at intensity 4. A thick pulp of about 2.5% dry solids was obtained. White pieces of the glue film were clearly visible. These pieces could be rubbed apart between the fingers. This indicates that the DIP fibers can be separated from the adhesive film particles by gentle screening.

### Example 5

5 grams of Ivana D4 wood glue was applied onto an ECOR 100% deinked pulp (DIP) FlatCOR platelet (Ø˜12 cm; 17 g) in stripes and distributed into one layer with a spatula. In the same way 5 grams of Ivana D4 wood glue was applied to another ECOR 100% deinked pulp (DIP) FlatCOR platelet (Ø˜12 cm; 15 g). After 15 minutes drying, the two platelets were put together and left to dry for 24 hours at room temperature with a weight of 1600 grams on top of the sandwich. After that the sandwich was cut axially in two identical circle segments.

One half of the dry sandwich (˜18 g) was left in 1 l water for 10 minutes to soak completely. The ECOR platelets could be taken apart at the side and it was clear that the glue could be removed as one continuous film.

The other half was subsequently torn apart by hand. All wet material was repulped with a household blender (Bagimex: BL10-powerblender, 1400 Watt) during 20 s at intensity 4. A thick pulp of about 2% dry solids was obtained. White pieces of the glue film were clearly visible. These pieces could not be rubbed apart between the fingers. This indicates that the DIP fibers can be separated from the adhesive film particles by regular screening.

### Example 6

3 grams of Bison Tix gel glue was applied onto an ECOR 100% deinked pulp (DIP) FlatCOR platelet (Ø˜12 cm; 18 g) in stripes and distributed into one layer with a spatula. In the same way 3 grams of Bison Tix gel glue was applied to another ECOR 100% deinked pulp (DIP) FlatCOR platelet (Ø˜12 cm; 18 g). After about 15 minutes drying, the two platelets were put together and left to dry for 24 hours at room temperature with a weight of 1600 grams on top of the sandwich. After that the sandwich was cut axially in two identical circle segments.

One half of the dry sandwich (˜24 g) was left in 1 l water for 10 minutes to soak completely. The ECOR platelets could be taken apart at the side and it was clear that the glue could be removed as one continuous film.

The other half was subsequently torn apart by hand. All wet material was repulped with a household blender (Bagimex: BL10-powerblender, 1400 Watt) during 20 s at intensity 4. A thick pulp of about 2% dry solids was obtained. Yellow pieces of the glue film were clearly visible. These pieces could not be rubbed apart between the fingers. This indicates that the DIP fibers can be separated from the adhesive film particles by regular screening.

### Example 7

4 grams of Bison Polymax professional SMP polymer was applied onto an ECOR 100% deinked pulp (DIP) FlatCOR platelet (Ø˜12 cm; 18 g) in stripes and distributed into one layer with a spatula. In the same way 4 grams of Bison Polymax professional SMP polymer was applied to another ECOR 100% deinked pulp (DIP) FlatCOR platelet (Ø˜12 cm; 20 g). After about 15 minutes drying, the two platelets were put together and left to dry for 24 hours at room temperature with a weight of 1600 grams on top of the sandwich. After that the sandwich was cut axially in two identical circle segments.

One half of the dry sandwich (˜18 g) was left in 1 l water for 10 minutes to soak completely. The ECOR platelets could be taken apart at the side and it was clear that the glue could be removed as one continuous film.

The other half was subsequently torn apart by hand. All wet material was repulped with a household blender (Bagimex: BL10-powerblender, 1400 Watt) during 20 s at intensity 4. A thick pulp of about 2% dry solids was obtained. White pieces of the glue film were clearly visible. These pieces could not be rubbed apart between the fingers. This indicates that the DIP fibers can be separated from the adhesive film particles by regular screening.

### Example 8

Two ECOR FlatCOR UA Brown panels were glued to each other with a polyester hot melt adhesive and one layer of a heat cured one component powder coating was applied to it by hot pressing (150° C., Adkins ASMC 28 Heat Press). This powder coating, which is an adhesive in the sense of the present invention, was based on Uralac P 1021R and Uralac P 1910C (applied together at 240 g/m2) obtained from DSM Resins (Zwolle, The Netherlands). A piece of 6×4 cm (30 g) of panel was left in 1 l water for 10 minutes to soak completely. The wet panel composition could easily be torn apart by hand.

All wet material was repulped with a household blender (Bagimex: BL10-powerblender, 1400 Watt) during 20 s at intensity 4. A thick pulp of about 3% dry solids was obtained. Pure white pieces of the powder coating were clearly visible, as well as flakes of the polyester hot melt adhesive. The pieces of the powder coating were visually different from the flakes of adhesive. The powder coating pieces could not be rubbed apart between the fingers.

### Example 9

An untreated MDF Panel having dimensions of 300×400×18 mm (l×w×h), weighing 1.366 kg was one sided coated with a polyester hot melt adhesive. An amount of 36 g of the molten hot melt adhesive was applied with a roller. After cooling down, the panel was immersed in water. After 48 hours the thickness of the panel increased to mm. The hot melt adhesive was released from the panel as one intact film. The remainder of the panel was pulverized in a household blender (Bagimex: BL10-powerblender, 1400 Watt).

1. A method to enable recycling of a panel comprising as a core structural component a polysaccharide fibre based plate at least one side of which is covered with a layer of a non water soluble adhesive, the method comprising immersing the panel in an aqueous liquid at least until the polysaccharide fibre based plate has absorbed an amount of liquid that leads to detachment of the adhesive from the polysaccharide fibres and at least partial detachment of neighbouring polysaccharide fibres from each other, resulting in a mixture of at least partially individualised polysaccharide fibres and separate adhesive, and thereafter removing the adhesive from the mixture.

2. A method according to claim 1, wherein the adhesive is a solid while the panel is immersed, wherein the adhesive is removed using a mechanical method such as sieving, sedimentation or centrifugation.

3. A method according to claim 1, wherein the at least one side of the plate is substantially completely covered with the layer of adhesive.

4. A method according to claim 1, wherein the panel is mechanically broken up into pieces having a volume of at most 100 cm³ before it is immersed in the aqueous liquid.

5. A method according to claim 1, wherein the panel is mechanically broken up into pieces having a volume of at most 50 cm³ before it is immersed in the aqueous liquid.

6. A method according to claim 1, wherein the adhesive is a hot melt adhesive.

7. A method according to claim 6, wherein the hot melt adhesive has a melting temperature between 80° C. and 250° C.

8. A method according to claim 6, wherein the hot melt adhesive comprises a polyester polymer.

9. A method according to claim 8, wherein the polyester polymer is a condensation polymer.

10. A method according to claim 8, wherein the polyester polymer has a weight averaged molecular weight (Mw) between 15,000 and 30,000 g/mol.

11. A method according to claim 8, wherein the polyester polymer has a crystallinity of between 5 and 40%.

12. A method according to claim 1, wherein the panel is a multilayer panel comprising multiple stacked sub-panels, wherein each sub-panel comprises as a core structural component a polysaccharide fibre based plate and in that the sub-panels are interconnected using the said non water soluble adhesive.

13. A method according to claim 12, wherein the multilayer panel is provided with a surface coating that is impervious to water.

14. A method according to claim 13, wherein the surface coating is a coating that is formed in situ on the panel using a heat curable one component powder.

15. A method according to claim 14, wherein the powder comprises a thermal initiation system comprising a peroxide, preferably an organic peroxide.

16. A method according to claim 14, wherein the powder comprises a polyester resin and a co-crosslinker chosen from the group of vinylethers, vinylesters, methacrylates, acrylates, itaconates and mixtures thereof.

17. A method according to claim 1, wherein the polysaccharide fibres are cellulosic fibres.

18. A method according to claim 17, wherein the polysaccharide fibres are of plant origin.

19. A method according to claim 1, wherein the polysaccharide fibre based plate contains less than 5% binder, preferably less than 4, 3, 2 or 1% binder up to even no binder.
